(19) United States
(12) Patent Application Publication
(10) Pub. No.: US 2026/0021978 A1
(43) Pub. Date: Jan. 22, 2026

(54) LOADING SYSTEM

(71) Applicant: Rein Posthumus, Dalhart, TX (US)

(72) Inventor: Rein Posthumus, Dalhart, TX (US)

(21) Appl. No.: 19/272,949

(22) Filed: Jul. 17, 2025

Related U.S. Application Data
(60) Provisional application No. 63/673,403, filed on Jul. 19, 2024.

(51) Int. Cl. B65G 65/22; B65G 33/26

(52) U.S. Cl. CPC B65G 65/22; B65G 33/26; B65G 2814/0343

(57) ABSTRACT

An apparatus includes a material transport channel having a first side and an opposite second side. The apparatus further includes a first loading auger at least partially positioned within the material transport channel and a first side auger positioned adjacent the first side of the material transport channel. The first side auger is configured to direct material from a surface toward the material transport channel via rotation of the first side auger, and the first loading auger is configured to direct material within the material transport channel from a bottom portion of the material transport channel towards an upper portion of the material transport channel via rotation of the first loading auger.

### PRIORITY CLAIM

This application claims the benefit of priority under 35 U.S.C. § 119(e) to U.S. Provisional Patent Application No. 63/673,403, filed on Jul. 19, 2024, the entire contents of which are hereby incorporated by reference in their entirety.

### TECHNICAL FIELD

The present invention relates generally to the field of machines for loading commodity materials.

### BACKGROUND

Collection of material from a surface is a necessary step in any number of processes in a variety of industries. Material to be collected may include liquids or solids. For example, in the livestock industry, it is often necessary to collect feed from a granary floor or other surface, whether the feed is fibrous, pelletized, or in a slurry form. Also in the livestock industry, manure may need to be collected from the floor of a livestock pen, the manure being in solid or slurry form. In a transportation application, snow removal from streets may involve moving snow in various stages of melt from the surfaces, whether dry powder or slush. In construction applications, removal of dirt and debris may be required as part of workplace preparation or cleanup efforts.

Efficient collection methods and associated apparatuses and system can assist with the collection of material while saving time and energy.

### SUMMARY OF THE INVENTION

In various embodiments, the present disclosure provides a material handling apparatus that includes a material transport channel flanked by one or more side augers and containing one or more loading augers. The side augers are configured to collect material from a surface and direct it into the material transport channel, while the loading augers are positioned within the channel to elevate or convey the material from a lower portion of the channel to an upper portion. This dual-auger configuration enables efficient material intake and vertical transport, making the apparatus particularly suitable for use in agricultural, industrial, or livestock environments where bulk material must be collected and transferred.

In some embodiments, the apparatus includes a pair of side augers positioned on opposite sides of the material transport channel, each configured to draw material inward from the surrounding surface. The side augers may be partially recessed into the channel to facilitate smooth material transfer. The loading augers within the channel may be arranged in counter-rotating pairs to optimize material movement and reduce clogging. The channel itself may include a tapered lower portion to concentrate material flow and improve auger efficiency.

The apparatus may further include one or more wings coupled to the side augers. These wings may include engagement surfaces that guide material toward the augers and may be hingedly or pivotally mounted to allow for dynamic adjustment based on environmental constraints. In some embodiments, the wings are biased outward using springs or hydraulic actuators, enabling the apparatus to adapt to varying widths or contours of the operating environment. Skids may be included on the wings to maintain proper spacing from vertical or horizontal surfaces and to facilitate smooth movement along irregular terrain.

In certain implementations, the apparatus is integrated into a larger material loading system that includes a material storage volume, such as a trailer or bin. A storage auger may be positioned within the storage volume to distribute incoming material from the transport channel toward the rear of the storage space. The system may be mobile, with a vehicle connection for towing and an onboard engine and drivetrain to power the augers and wheels. The transport channel may be hingedly connected to the storage volume, allowing its angle to be adjusted based on terrain or operational needs. A level guide may be included to maintain a consistent height of the channel relative to the ground during operation.

The disclosure also encompasses methods of manufacturing and assembling such a system, including steps for operatively connecting the augers to the transport channel and coupling the transport channel to a storage volume. These methods enable scalable and modular construction of the system, allowing it to be tailored to specific use cases or environments.

### BRIEF DESCRIPTION OF THE DRAWINGS

FIG. 1A is a perspective view of a material collection system according to an embodiment having two loading augers, the system in a transport position.

FIG. 1B is a perspective view of a material collection system according to an embodiment having a single loading auger, the system in a transport position.

FIG. 2A is a detailed perspective view of a material collection system according to an embodiment having two loading augers, the system in an operational position.

FIG. 2B is a detailed perspective view of a material collection system according to an embodiment having a single loading auger, the system in a transport position.

FIG. 3A is a front view and a front detail view of a material engagement portion of a material collection system according to an embodiment in which an auger motor is positioned towards the bottom of the system.

FIG. 3B is a side view with a cutaway of a material engagement portion of a material collection system according to an embodiment.

FIG. 3C is a front view and a front detail view of a material engagement portion of a material collection system according to an embodiment in which the material collection system includes a channel cover and deflector.

FIG. 3D is a side view of a material engagement portion of a material collection system according to an embodiment in which the material collection system includes a channel cover and deflector.

FIG. 4A is a perspective view of a material collection system according to an embodiment having a two loading augers, the system in a transport position.

FIG. 4B is a perspective view of a material collection system according to an embodiment having a single loading auger, the system in an operational position.

FIG. 5A is a side view of a material collection system according to an embodiment having a two loading augers, the system in a transport position.

FIG. 5B is a side view of a material collection system according to an embodiment having a single loading auger, the system in an operational position.

FIG. 6A is a perspective view of a material collection system according to an embodiment having a two loading augers, the system in a transport position.

FIG. 6B is a perspective view of a material collection system according to an embodiment having a single loading auger, the system in an operational position.

FIG. 7A is a side view of a material collection system according to an embodiment having a two loading augers, the system in a transport position.

FIG. 7B is a side view of a material collection system according to an embodiment having a single loading auger, the system in an operational position.

FIG. 8A is a perspective view of a material collection system according to an embodiment having a two loading augers, the system in a transport position.

FIG. 8B is a perspective view of a material collection system according to an embodiment having a single loading auger, the system in an operational position.

FIG. 9A is a side view of a material collection system according to an embodiment having a two loading augers, the system in a transport position.

FIG. 9B is a side view of a material collection system according to an embodiment having a single loading auger, the system in an operational position.

FIG. 10A is a perspective view of a material collection system according to an embodiment having a single loading auger, the system in an operational position.

FIG. 10B is a side view of a material collection system according to an embodiment having a single loading auger, the system in an operational position.

FIG. 11A is a perspective view of a material collection system according to an embodiment having a single loading auger, the system in an operational position.

FIG. 11B is a side view of a material collection system according to an embodiment having a single loading auger, the system in an operational position.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting. Use of the terms “about” or “around” should be understood to encompass the claimed value and a range within 10% of that value or as would otherwise be understood by a person skilled in the art of material processing machines.

Provided herein is a system for collecting material from a surface, such as a floor, roadway, or ground surface in agricultural, industrial, or commercial environments. The system is designed to efficiently gather a wide variety of materials, accommodating both solid and semi-solid substances. In particular, the system is capable of collecting granular materials—such as animal feed, seeds, sand, gravel, and small stones—as well as liquids and slurries, including mud, wastewater, and animal waste. This versatility allows the system to be deployed in diverse settings, including barns, feedlots, construction sites, and processing facilities. In various embodiments, the apparatus includes a material transport channel having a first side and an opposite second side. A first loading auger is at least partially disposed within the material transport channel and is configured to convey material from a lower portion of the channel toward an upper portion through rotational movement. The loading auger may be driven by an electric, hydraulic, or mechanical motor and may include a helical screw element housed within a cylindrical or semi-cylindrical casing. The auger may be positioned centrally within the channel or offset depending on the desired flow characteristics.

Positioned adjacent to the first side of the material transport channel is a first side auger. This side auger is configured to engage with material located on a surface external to the channel and direct that material inwardly through an opening in the first side of the channel. In some embodiments, the side auger may extend partially into the channel to facilitate a smooth transition of material. The auger may be mounted in a trough or guide structure that aligns the material flow path with the channel opening. A second side auger may be similarly positioned adjacent the second side of the channel to provide bilateral material collection capability.

In some embodiments, a second loading auger is positioned adjacent to the first loading auger within the material transport channel. The second loading auger may rotate in a direction opposite to that of the first loading auger, thereby creating a converging or complementary material flow pattern that enhances vertical transport efficiency and reduces the likelihood of clogging. The channel may include a tapered bottom portion, narrowing toward the base to concentrate material flow and improve auger engagement.

The apparatus may further include one or more wings coupled to the side augers. Each wing may include an engagement portion configured to guide material from the surrounding surface toward the respective side auger. The wings may be hingedly attached to the auger housing or frame, allowing for angular adjustment. In some embodiments, the wings are biased outward using springs or hydraulic pistons, enabling them to adapt to varying widths or contours of the operating environment. Skids may be mounted to the wings to maintain a consistent spacing from vertical or horizontal surfaces and to reduce wear during operation.

The apparatus may be integrated into a material loading system that includes a material storage volume, such as a trailer or bin. The material transport channel is configured to deliver material into the storage volume, where a storage auger may be positioned along at least a portion of the length of the volume. The storage auger is configured to move material from a front portion of the storage volume toward a rear portion, thereby distributing the load evenly. In some embodiments, the storage auger is inclined, with the front end positioned lower than the rear end to facilitate gravity-assisted movement.

The system may be mobile and include a vehicle connection for towing, or it may include an onboard engine and drivetrain to provide self-propulsion. In some configurations, the material transport channel is hingedly connected to the storage volume, allowing the angle of the channel to be adjusted based on terrain or operational requirements. A level guide may be positioned adjacent the bottom portion of the channel to maintain a consistent height relative to the ground during operation, ensuring optimal material intake.

### Material Collection System

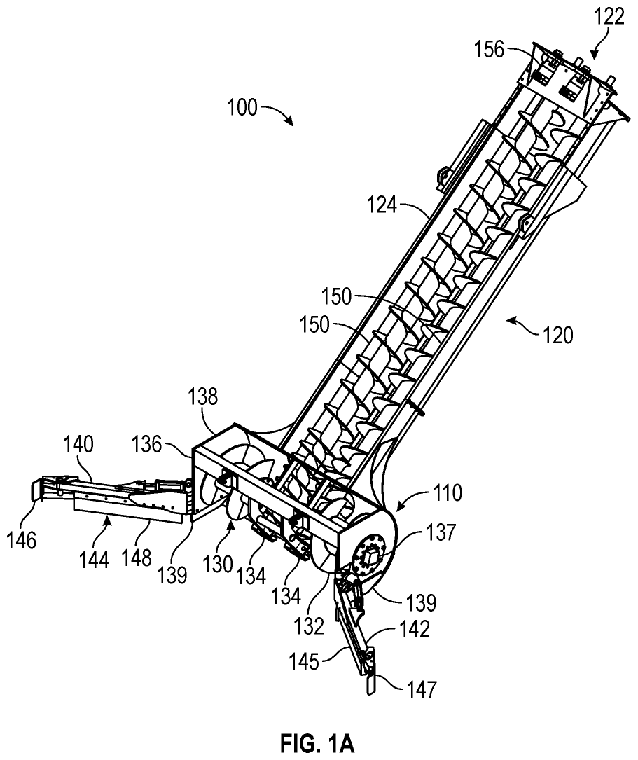

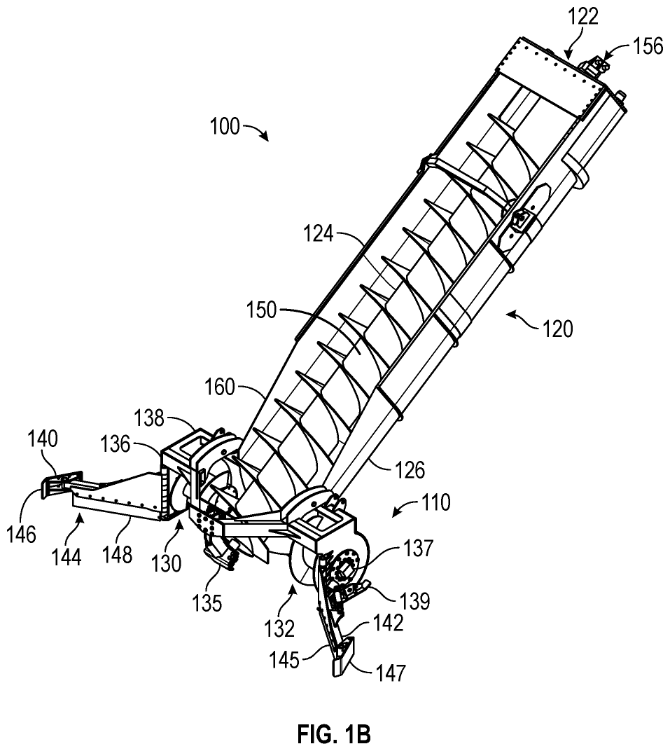

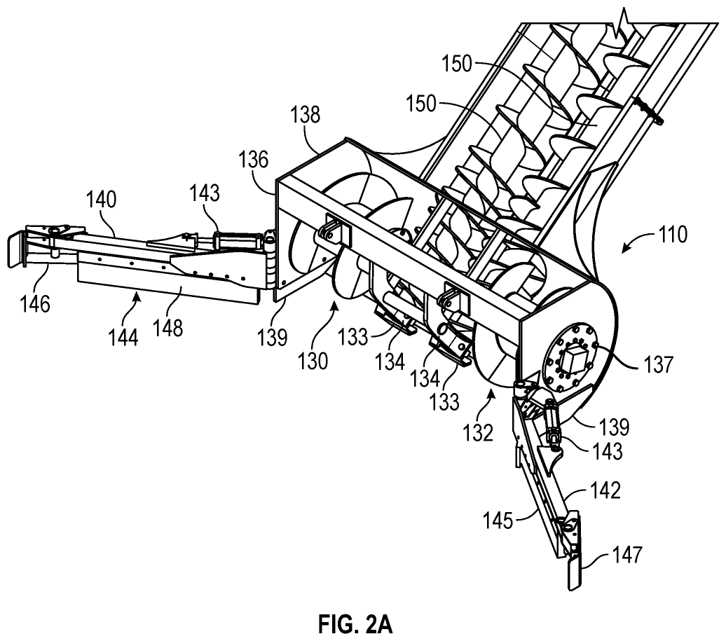

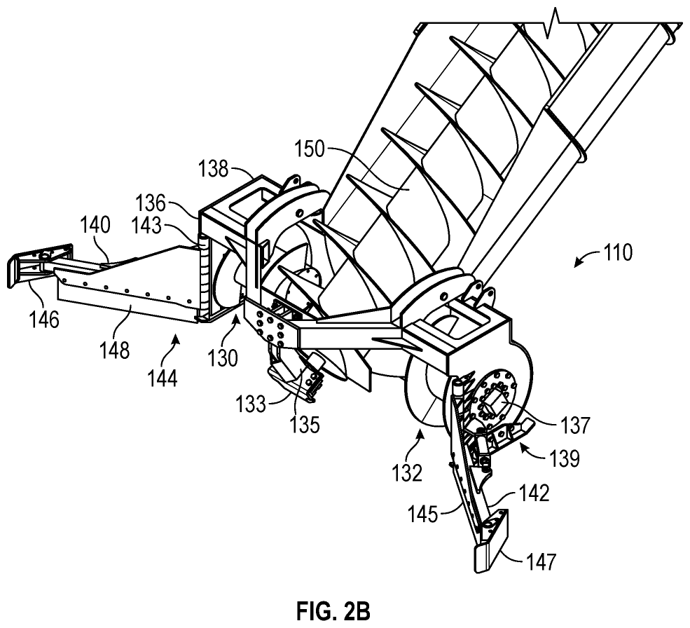

Referring to FIG. 1A-2B, a material collection system 100 as provided herein includes a material engagement portion 110 and a material loading portion 120. The material engagement portion 110 includes at least one side auger 130 that is configured to direct material contacted by the side auger towards one or more loading augers 150 positioned adjacent the side auger and within a material transport channel 124 of the material loading portion. The at least one side augers 130 132 preloads or feeds or directs material to the loading auger 150. The loading auger 150 directs material fed to the loading auger by the side auger 130 upward in a material transport channel 124 towards an outlet 122 of the material transport channel. When there are more than one side augers 130 132, the loading auger 150 is positioned between at least two side augers. For example, in embodiments featuring two side augers 130 132, the loading auger 150 is positioned between the first side auger and the second side auger, such that each side auger feeds or directs material collected from the surface to the loading auger.

Depending on the material, the system may simultaneously crush, mix, homogenize, or otherwise process the material while moving and collecting it. For example, the material collection system 100 may, by engagement of the material with the side auger 130 and the loading auger 150, crush particulate or discreet solid materials, such as dirt clumps, limestone chunks, or dry animal waste (manure), as it collects the material. The material collection system 100 may, by engagement of the material with the side auger 130 and the loading auger 150, mix slurry or fluid-like materials, such as grain seeds, animal waste, manure or other animal waste, powders, cement mixtures, acid-extracted mineral slurry, cellulose slurry, or fertilizer slurry. The material collection system 100 may, by engagement of the material with the side auger 130 and the loading auger 150, separate or mulch fibrous material, such as hay, alfalfa, biomass, or wood fibers.

It should be understood that based on the general principles provided herein, a system including different numbers of augers may be developed. For simplicity, this disclosure refers to “the side augers” and “the loading augers,” but it should be understood that there may be only one side auger and/or only one loading auger. The material collection system may include a single side auger 130 positioned on one side of the one or more loading augers 150 adjacent to the one or more loading augers such that the side auger is able to load or feed material to the one or more loading augers. However, as explained in greater detail below, the material collection system is not limited to a single side auger 130, nor is it limited to using two opposing side augers. Similarly, the system may include a single loading auger 150, as illustrated in FIG. 1B, or may include two loading augers, as illustrated in FIG. 1A. In embodiments featuring two side augers 130 132, the one or more loading augers 150 are positioned between the first side auger and the second side auger, such that the side augers feed or direct material collected from the surface to the one or more loading auger. In some embodiments, the system includes more than two loading augers.

In some embodiments, the system 100 includes a single loading auger 150, as shown in FIGS. 1B and 2B. In other embodiments, two loading augers 150 may be used, as shown in FIGS. 1A and 2A. In some embodiments featuring two loading augers, the augers are positioned in a complimentary arrangement, side by side (as shown) or stacked one above another. The rotational direction of the loading augers 150 may be in the same direction, but are more preferably in opposite directions so as to better direct material up the material loading portion 120 of the system 100 toward the outlet 122.

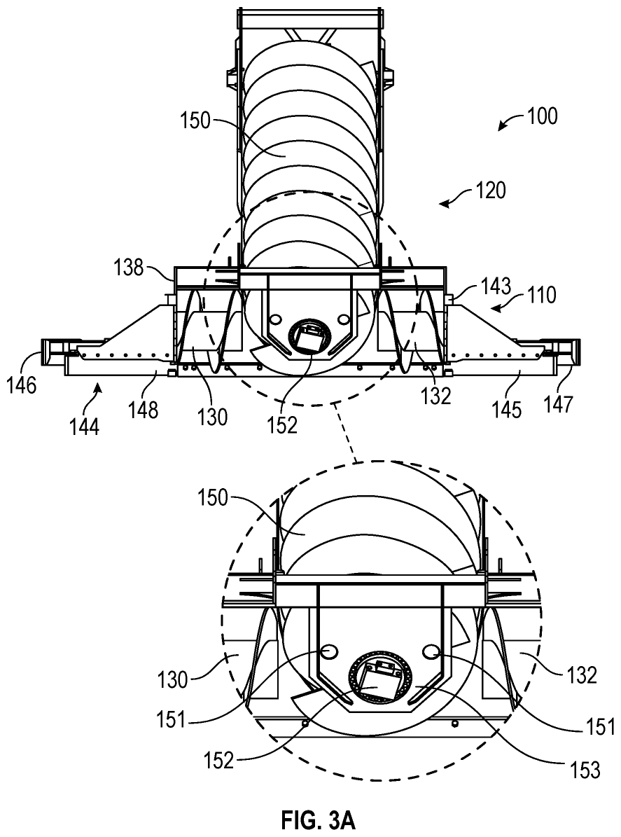

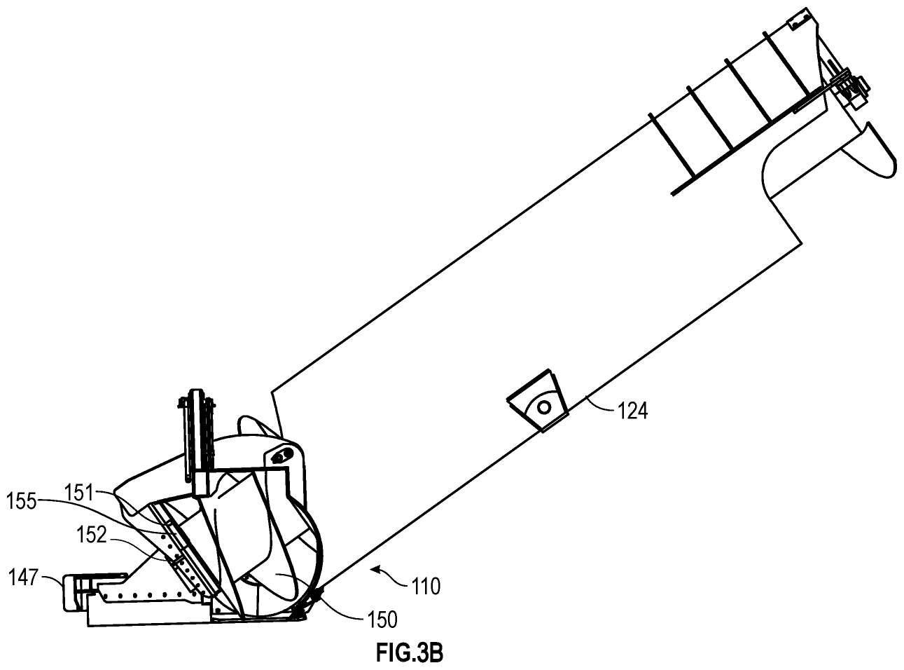

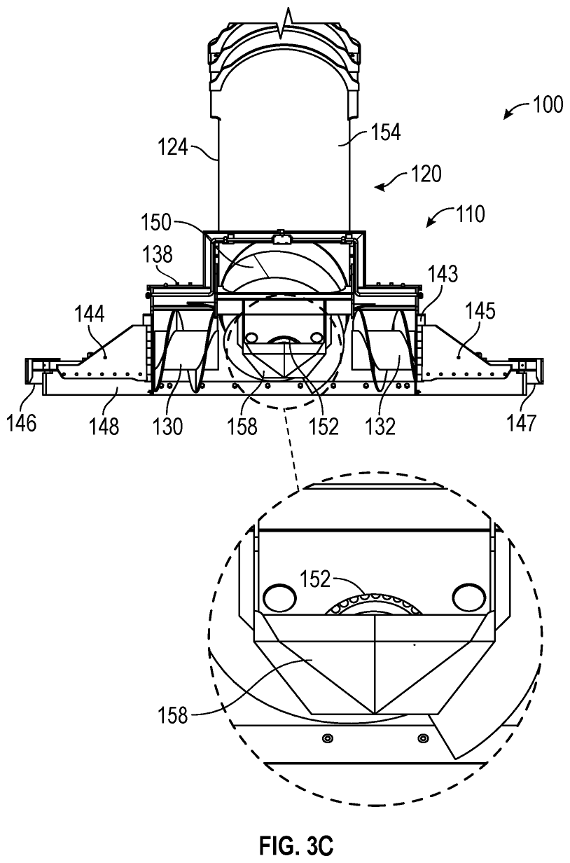

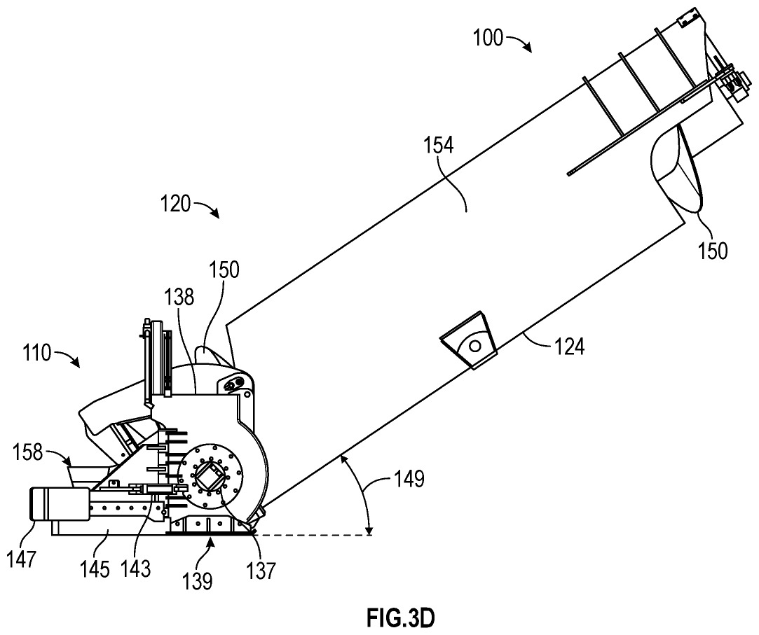

The side augers 130 132 and the loading auger 150 each include a helical blade wrapped around a central shaft. As the central shaft rotates, material contacted by the helical blade is moved axially by the helical blade. For the side augers 130 132, the augers are configured such that the material is pushed towards a center portion of the material collection system 100 by the rotation of the side auger shafts. For the loading auger 150, material received from the side augers 130 132 is pushed into the material loading portion 120 of the system and towards an outlet 122. The central shaft of a side auger 130 extends from an end toward the loading auger 150. In some embodiments, the central shaft of the loading auger 150 is about perpendicular or 90 degrees relative to the central shaft of a side auger 130. The loading auger 150 may be further angled relative at an angle 149 to a horizontal reference (see FIG. 3C) such that an outlet 122 of the material loading portion 120 is positioned at a distance laterally from the side augers and the material engagement portion 110. In various embodiments, the angle 149 ranges 15 to 80 degrees, or from 25 to 60 degrees, or from 30 to 50 degrees.

In some embodiments, the helical blade of the side auger 130 is tapered or otherwise shaped so as to provide close clearance with a helical blade of the loading auger 150 during rotation of the side auger central shaft. In some embodiments, the helical blade of the loading auger 150 is tapered or otherwise shaped so as to provide close clearance with the helical blade of the side augers 130 132 during rotation of the augers. In some embodiments, the clearance of the side auger 130 and loading auger 150 is adjustable to a predetermined or a desired spacing. Adjusting the clearance of these parts may be useful for effectively collecting different materials (e.g., tighter clearance to collect fluids or smaller particles) or, if desired, crushing or otherwise processing the material as it is collected.

The side augers 130 132 and the loading augers 150 may be any desired size, chosen to be appropriate for the material to be collected. In some embodiments, the side augers 130 132 and the loading augers 150 have the same diameter of helical blades. In some embodiments, the side augers 130 132 and the loading augers 150 have the different diameter of helical blades. In some embodiments, the side augers 130 132 have a diameter ranging from about 6 inches to about 60 inches, or from about 12 inches to about 54 inches, or from about 24 inches to about 48 inches, or from about 36 inches to about 48 inches. Other ranges encompassed within these ranges are also contemplated. For example, the helical blade of the side augers 130 132 may have a diameter of about 6, 7, 8, 9, 10, 11, 12, 13, 14, 15, 16, 17, 18, 19, 20, 21, 22, 23, 24 inches. The helical blade of the side augers 130 132 may have a diameter of about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 inches. Independently, the helical blade of the loading augers may have a diameter of about 6, 7, 8, 9, 10, 11, 12, 13, 14, 15, 16, 17, 18, 19, 20, 21, 22, 23, 24 inches. The helical blade of the loading augers may have a diameter of about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 inches.

The side augers 130 132 may be housed in an auger housing 138. The auger housing 138 provides structural support to the side augers 130 132, and may act as a guard for the augers to prevent unwanted contact with the auger screws. The auger housing 138 may provide support to the side augers 130 132 such that the central shafts of the side augers are fixed in their positions. The auger housing 138 may be shaped to at least partially compliment and conform to the shape of the auger, acting as screw guards, thereby reducing void space within the material engagement portion 110 of the system 100. The auger housing 138 may be shaped so as to assist the augers in directing material towards the center of the material engagement portion 110 to be contacted by the loading augers 150. For example, the auger housing 138 may include sloped surfaces that direct material contacted by the side augers 130 132 towards the center portion of the material engagement portion 110 of the collection system 100.

The auger housing 138 in some embodiments includes feet 139 or other structures to contact a surface on which material is disposed during operation of the material collection system. The feet 139 or other structures may include feet, guides, skids, skis, wheels, or other structures as appropriate to contact the surface, though for simplicity they are referred to as feet in the following. The feet 139 are positioned and sized so as to prevent the side augers 130 132 from contacting the surface directly, thus preventing damage to the augers and to the surface. In some embodiments, the feet 139 are positioned and sized to maintain the side augers 130 132 about 0.1 to about 6 inches from the surface, or about 0.5 to about 3 inches from the surface, or about 1 inch to about 2 inches from the surface. In some embodiments, the feet 139 or skids serve as sacrificial material, designed to be worn by contact with the surface without harm to the rest of the auger housing 138 or the side augers 130 132 and able to be replaced at less expense than a replacement of the entire auger housing.

In some embodiments, the auger housing 138 and the housing feet 139 are a made of a rigid or durable plastic, such as though not limited to: high density polyethylene (HDPE), acetal, polyamide (nylon), polycarbonate, acrylonitrile butadiene styrene, polyetheretherketone (PEEK), ultra-high weight polyethylene, polytetrafluoroethylene, polyethylene terephthalate, or a combination of any two or more of these materials. In some embodiments, the auger housing 138 and the housing feet 139 are made of metal, such as though not limited to: iron, carbon steel, stainless steel, copper, nickel, steel alloys, or combinations of any two or more of these materials. In some embodiments, the auger housing 138 and the housing feet 139 are made of synthetic materials, such as though not limited to carbon fiber and/or carbides. In some embodiments, the auger housing 138 and the housing feet 139 are made of a combination of any of the previously listed materials, for example, having a first body portion fashioned out of carbon fiber while including feet 139 formed of stainless steel. Other combinations are also contemplated. This example is provided as a non-limiting example—as will be understood by those skilled in the art, other material combinations may be selected from the listed materials or may include others, depending on the mechanical strength and wear resistance properties appropriate for the application of the system 100.

The loading augers 150 are contained in a material transport channel 124. The material transport channel provides support to the material as it is moved by the loading augers, and directs the material from a bottom portion toward the outlet 122. The material transport channel 124 may be enclosed (i.e., a pipe or closed channel), but preferably has at least a portion that is open such that movement of the material through the material loading portion 120 can be observed, which may inform an operator to adjust the operating speed of the system 100. The material transport channel 124 may be formed of any suitable material, including but not limited to the plastics, metals, and composite materials previously listed. Combinations of construction materials is also contemplated. The material transport channel 124 may have a shape that is complimentary or that corresponds to the shape of the loading augers 150. For example, the material transport channel 124 may have a sloped bottom portion that directs material towards the center of the material transport channel. The material transport channel may include a tapered portion 126, as shown in FIG. 1B. The tapered portion 126 has a width that is more narrow that the width of the rest of the material transport channel 124. The tapered portion 126 may be formed by angles or curves in the walls of the material transport channel 124. The diameter of the loading auger 150 may likewise be tapered to follow the taper of the material transport channel 124. The tapered portion 126 serves to assist in directing material from the side augers up into the material transport channel and to prevent the shell from contacting the surface during operation.

Rotational power is provided to the side augers 130 132 by one or more motors 136 137. Preferentially, each side auger 130 132 is driven by an associated motor 136 137 independent of the other side auger. The motors 136 137 are preferentially operable at variable speeds, such that the speed of operation of the side augers 130 132 may be selected or adjusted by an operator. The motors are preferably positioned near the side augers as shown in FIGS. 1A-2B. However, it is also possible to position the motors anywhere required, so long as the rotational energy can be transmitted to the augers. For example, the motors may be positioned above or behind the augers, so long as the rotational power is translated to the augers. The motors may be electric (AC or DC), combustion powered (gasoline, diesel, natural gas), pneumatically-driven, or use any other motor known in the art. The motors 136 137 may be configured to receive electricity via an electrical pickup connection, which may be connected to, for example, an electrical supply from an engine. In some embodiments, the motors 136 137 may be powered by a truck or tractor.

In some embodiments, the loading augers 150 are anchored or supported by auger supports 134 and 135 at or near the central portion of the material engagement portion 110 of the system 100, and are powered by one or more motors 156 located at or near the top of the material loading portion 120. In such an embodiment, the auger supports 134 and 135 support the weight of the loading auger and provide a housing for an end of the auger shaft, thereby supporting the rotation of the auger shaft. In embodiments featuring a single loading auger 150, the auger support 135 may include extensions to assist with collecting the material fed by the side augers 130 132.

In some embodiments, as illustrated in FIG. 3A, one or more loading augers 150 are driven by motors 152 located at the bottom of system 100. Though one auger is illustrated in FIGS. 3A-3D, multiple loading augers 150 may be used. The auger 150 is supported within its channel by a support member 153, which may include one or more plates. In certain embodiments, the motor 152 is directly mounted or coupled to the support member 153. However, in other embodiments, the auger 150 and motor 152 are indirectly supported by the support member 153. For example, the motor 152 may be attached to a separate support plate 155 (see FIG. 3B), which is itself supported by the support member 153. This support plate may be held in place by one or more pins 151 connected to the support member 153. During operation, the support plate 155 can slide along the pins 151, allowing the motor 152 to move slightly along its axis or to wobble slightly side to side. As the auger motor 152 is indirectly supported by the support member 153, the mechanical strain on the support member caused by the operation of the auger is reduced. Similar motor supports may be used with multiple augers as well.

The motor 152 156 for the loading augers is preferably variable speed, such that an operating speed of the loading augers may be selected or adjusted by an operator. In some embodiments, the angular velocity of the side augers 130 132 matches the angular velocity of the loading augers 150. Similar to the side augers, the motors for the augers may be positioned in locations other than where shown in the figures, so long as the rotational power is able to be translated to the augers. The motor 152 or other connections for the augers may be protected by one or more shields 133 posited at an end of the auger assemblies, such that the shield deflects material that would otherwise contact the motor 152 or auger connection points. The motors 152 156 may be powered by electricity (AC or DC), combustion engines (gasoline, diesel, natural gas), pneumatic systems, or use any other motor known in the art. The motors 152 156 may be configured to receive electricity via an electrical pickup connection, which may be connected to, for example, an electrical supply from an engine. In some embodiments, the motors 152 156 may be powered by a truck or tractor.

As illustrated in FIGS. 3C and 3D, in some embodiments the material collection system 100 may include one or more channel covers overlaying the material transport channel 124. These channel covers, such as channel cover 154, may be configured to extend either partially or fully along the longitudinal axis of the material transport channel 124, depending on the specific application or operational requirements. The channel cover 154 keeps material pushed by the loading auger 150 within the material transport channel 124 during operation of the auger(s). Thus, the channel cover 154 serves to maintain the integrity and efficiency of the material transfer process by preventing material-such as grain, debris, or other particulate matter-displaced by the rotating action of the loading auger 150 from escaping the confines of the channel 124. In addition to containing the material, the cover may also provide structural reinforcement to the channel assembly and help shield internal components from environmental contaminants such as dust, moisture, or foreign objects. In some embodiments, the channel cover is integral with the material transport channel 124. In other configurations, the channel cover 154 may be removably fastened to the channel to allow for easy access during maintenance or cleaning operations.

With continued reference to FIGS. 3C and 3D, a deflector 158 may be positioned at or near the lower region of the material engagement portion 110 of the system 100. The deflector 158 may comprise one or more angled plates, blades, or curved surfaces designed to redirect incoming material away from the central longitudinal axis (midline) of the system as the system is moved through the material to be collected. The deflector 158 urges material toward the lateral collection zones adjacent to the wings 144 and 145. This redirection facilitates efficient engagement by the side augers 130 and 132, which are responsible for transporting material laterally into the material transport channel 124. By guiding material away from the central axis, the deflector 158 helps to minimize the accumulation of compacted or impacted debris at the front portion of the system during operation. This not only enhances the overall throughput and efficiency of the material collection process but also reduces the frequency of manual clearing or downtime due to clogging, and can prevent damage to motors or other machinery positioned at the leading portion of the system 100. As a result, the inclusion of the deflector contributes to extended operation intervals, improved material flow dynamics, and reduced maintenance requirements over time.

In some embodiments, the material loading system may employ a first side auger 130 and a second side auger 132. In some embodiments, the side augers 130 132 are placed in a horizontal and opposed relation, as shown in FIGS. 1A and 1B. In such an arrangement, the central axis of the first side auger 130 is substantially aligned with the central axis of the second side auger 132. In other embodiments, the side augers 130 and 132 are angled with respect to each other. The side augers 130 132 may each be a single auger, as shown or may each include two augers in a stacked arrangement or in an arrangement with a front auger positioned at least partially in front of a second, rearward auger. In embodiments featuring multiple side augers on a single side of the device, the augers may rotate in the same direction or may rotate in opposite or counter directions. Other arrangements may also be employed, depending on the needs of the user and the properties of the material to be collected or transport.

With continued reference to FIGS. 1A-3D, the material engagement portion 110 of the material collection system 100 in some embodiments includes one or more wings 144 145. As shown in FIGS. 1A-3, the wings 144 145 extend from the sides of the auger housing 138 and include a wing support 140 142. During operation of the collection system 100, the wings 144 145 contact material deposited on the surface before the system and direct the material towards the one or more side augers 130 132 as the system moves across the surface. Material contacts the wings and is pushed towards the center portion of the material engagement portion 110 due to the angle of the wings 144 145.

In some embodiments, the wings 144 and 145 are hingedly coupled to opposing lateral sides of the auger housing 138, thereby allowing the angular orientation of each wing to be selectively adjusted. Alternative coupling mechanisms may also be employed, including but not limited to pivot joints, sliding brackets, or flexible linkages. The wings 144 and 145 may be secured in a desired position using mechanical fasteners, tension locks, quick-release bolts, or other suitable locking mechanisms. In certain embodiments, the wings 144 and 145 are freely hingeable, permitting passive angular adjustment in response to external forces or environmental constraints.

In some configurations, the wings 144 and 145 are outwardly biased—i.e., urged away from the auger housing 138 or side augers 130 and 132—by one or more biasing devices 143. Such biasing devices may include, for example, compression springs, torsion springs, spring-loaded hinges, or hydraulic or pneumatic actuators. The biasing mechanism facilitates automatic deployment or expansion of the wings during operation. In embodiments where a maximum opening angle is defined, the biasing force is constrained such that the wings do not extend beyond the predetermined angular limit.

Additionally, the wing supports 140 and 142 may be operatively connected to the auger housing 138 or another structural component of the system via hydraulic cylinders, spring assemblies, or other force-transmitting elements. These connections may serve to maintain the wings 144 and 145 in a desired orientation or to dynamically adjust their position in response to operational conditions. Further, in some embodiments, the wings 144 145 are configured to be positioned in a closed position for transport of the system 100, in which the wings are positioned against the corresponding sides of the auger housing 138. The wings 144 145 in some embodiments include surface contact members 148, such as scrapers, configured to contact or nearly contact the surface wherein the material is disposed as the system 100 is operated. The surface contact members 148 may be a sacrificial material, as the repeated contact with the surface will cause wear on the material.

In some embodiments, the surface contact member 148 is a made of a rigid or durable plastics, such as though not limited to: high density polyethylene (HDPE), acetal, polyamide (nylon), polycarbonate, acrylonitrile butadiene styrene, polyetheretherketone (PEEK), ultra high weight polyethylene, polytetrafluoroethylene, polyethylene terephthalate, or a combination of any two or more of these materials. In some embodiments, the surface contact member 148 is made of metal, such as though not limited to: iron, carbon steel, stainless steel, copper, nickel, steel alloys, or combinations of any two or more of these materials. In some embodiments, the surface contact member 148 is made of synthetic materials, such as though not limited to carbon fiber and/or carbides. In some embodiments, the surface contact member 148 is made of a combination of any of the previously listed materials, for example, having a body portion fashioned out of carbon fiber while including a surface contacting edge formed HDPE. Other combinations are also contemplated. This example is provided as a non-limiting example—as will be understood by those skilled in the art, other material combinations may be selected from the listed materials or may include others, depending on the mechanical strength and wear resistance properties appropriate for the application of the system 100.

Continuing with reference to FIGS. 1A-2B, in certain embodiments, the material engagement portion 110 of the material collection system 100 may include one or more skids 146 and 147 configured to engage with external surfaces during operation. The skids 146 and 147 may be positioned at or proximate to the outer edges of the respective wings 144 and 145. In some implementations, the material collection system 100 may be deployed within an enclosed or partially enclosed environment, such as an animal feed storage silo, livestock pen, or other confined space. Such environments may exhibit irregular geometries or include channels of varying width. To accommodate these spatial variations, the wings 144 and 145 may be configured to dynamically articulate-opening or closing in response to contact with surrounding surfaces.

In operation, when a skid 146 or 147 encounters a surface, such as a wall or channel guide, it may transmit a reactive force to the corresponding wing support 140 or 142. This force may induce a change in the angular orientation or lateral position of the associated wing, thereby adjusting the effective width of the material engagement opening defined between the wings. In some embodiments, the skids 146 and 147 may be articulated or pivotally mounted, allowing them to conform to the contour of the contacted surface as the system traverses a path. This configuration facilitates adaptive alignment of the wings with the surrounding environment, enhancing material collection efficiency and reducing the likelihood of mechanical interference or system wear.

As previously discussed, the wings 144 145 may be biased outward by one or more biasing devices 143, and in such embodiments, the width of the opening can be adjusted dynamically by the change in the wings position, narrowing in response to contact by the skids 146 147 with the surface and opening again due to the bias when the contact with the surface is no longer present. For example, the material collection system 100 described herein could be operated in an enclosure having a circular footprint. When operated close to the walls, the wing 144 145 closest the wall will be closed at least partially due to contact by the skid 146 147 with the wall, but when the system is moved away from the way, the contact is removed and the wing will return to an open position.

### Bulk Material Collection and Transport Systems

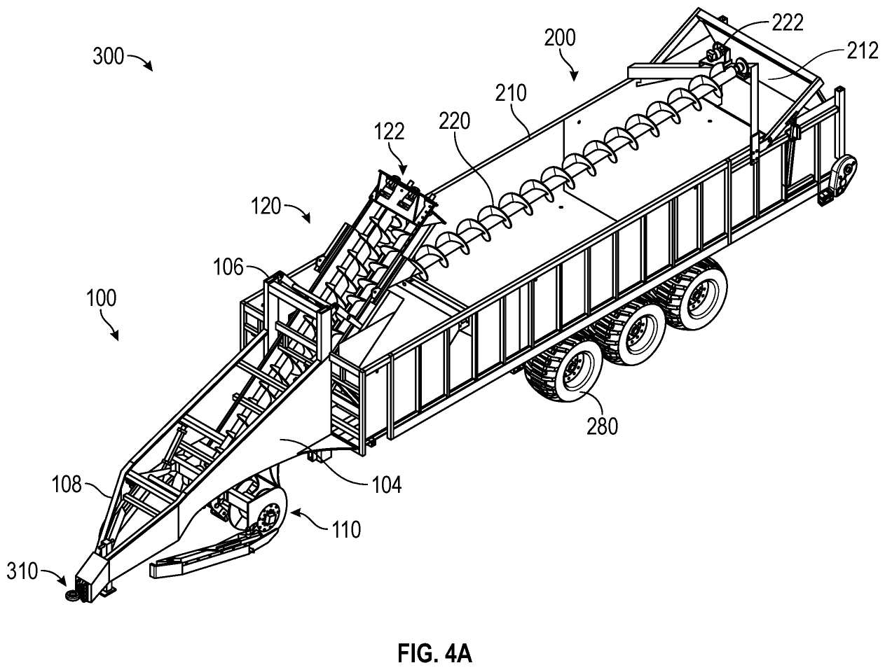

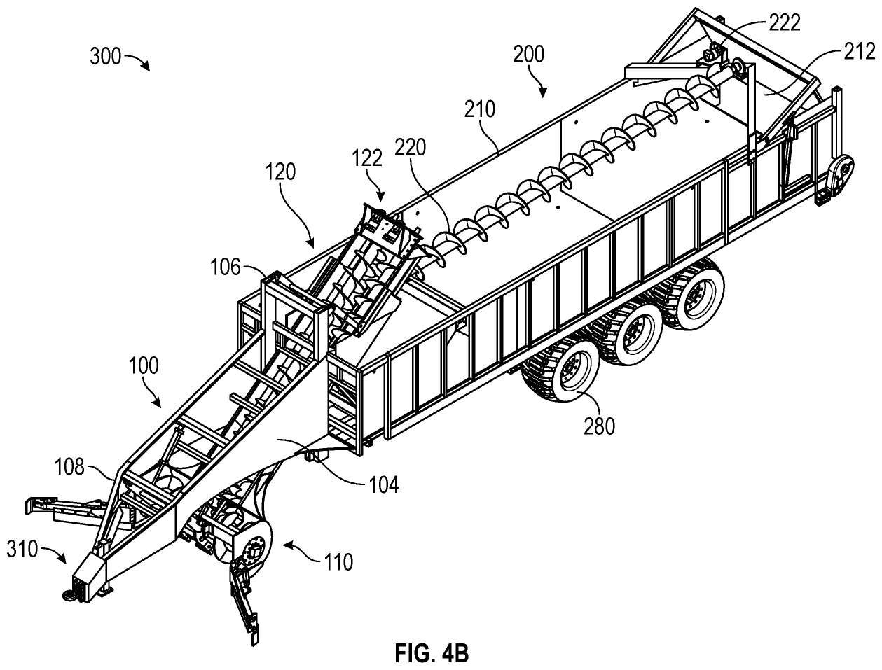

Turning now to FIGS. 4A-11B, presented herein is a combined system 300 for collecting and transporting materials. While various embodiments are illustrated in FIGS. 4A-9B, they share several common features, which are described below. The combined system 300 includes a material collection system 100 discussed previously (itself comprising the material engagement portion 110 and the material loading portion 120) and includes additional parts to receive, store, and/or transport the collected material. The combined system 300 includes a material collection system 100 and a storage portion 200, which defines a storage volume 210. In some embodiments, the material collection system 100 is connected to the storage portion 200 via one or more support structures. As shown in FIGS. 4A-11B, these support structures may include one or more support frames 106 that reinforce and stabilize the material collection system 100, particularly the material engagement portion 110 including the augers during operation. Additionally, a support housing 104 may at least partially enclose the material collection system 100, such as the material loading portion 120, providing further structural support. The support structures may also include a trailer tongue 108, which can feature a hitch 310 or other coupling mechanism for attaching the combined system 300 to a tractor or other vehicle for transport and/or material collection.

The storage volume 210 is configured to receive material discharged from the outlet 122 of the material loading portion 120 of the material collection system 100. During operation, material is initially gathered by the material engagement portion 110 via the one or more augers 130 132, and is then conveyed to the material loading portion 120 where the loading auger 150 directs the material up the material transport channel 124 toward the outlet 122. Once at the outlet 122, the material is deposited into the storage volume 210, which may be shaped or oriented to optimize material distribution and, if desired, compaction. As a result, material present on a surface can be effectively and efficiently collected, transferred, and stored within the storage volume 210 for subsequent handling or transport.

The storage volume 210 includes one or more walls that form and enclosure for holding collected material. The storage volume 210 is not limited to any particular shape. The storage volume 210 may be a rectangular container, as shown in FIG. 4A-9B, or may be a square container, a round or spherical container, a semi-spherical container, or may have an irregular shape. The storage volume 210 may have tapered or sloped walls, such that the bottom of the container is larger than the top, or such that the top of the container is larger than the bottom. The storage volume 210 may have an open top, as shown in FIG. 4A-9B, or may be partially enclosed, or may be nearly full enclosed with an opening only to receive material from the outlet 122 or having a duct to direct material from the outlet through an opening in the volume. The storage volume may include an outlet gate 212 that may be operable for depositing the material at a desired location. The material storage volume 210 may include wheels 280 such that it may be transported. For example, in some embodiments, the combined system 300 may be towed or pulled by another vehicle, such as though not limited to a truck or tractor. In some embodiments, the combined system 300 includes a motor or other power plant to provide power to the wheels, such that it can be driven without towing by another vehicle.

The storage portion 200 includes a level auger 220 extending along at least a portion of the length of the storage volume 210. The level auger 220 in operation rotates to direct material stored near the front of the storage volume 210 (the portion closest to the outlet 122) towards the rear of the storage volume, thereby keeping the level of material in the volume somewhat level and avoiding piling of the material in the front of the volume. The level auger 220 may also be operated to assist in unloading material from the storage volume 210.

The level auger is driven by a motor 222, and may be an electric, combustion, pneumatic motor, or any motor that can provide the rotational power to the auger. The level auger 220 may be positioned at least partially above the storage volume 210. Portions of the level auger 220 may be positioned within the storage volume 210. In some embodiments, the level auger 220 is horizontal with respect to a horizontal reference (e.g., the operating surface or ground), but in others the level auger is positioned at an angle with respect to the horizontal reference. For example, in some embodiments, the level auger is angled about 0°, 5°, 10°, 15°, 20°, 25° or 30 with respect to a horizontal reference. All discreet angles are contemplated in this range, such that the auger is angled 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, or 30° with respect to a horizontal reference. The level auger 220 may be angled such that the auger is lower near the front of the storage volume 210. In other embodiments, the level auger 220 is angled such that the auger is lower near the rear of the storage volume 210.

In some embodiments, as illustrated in FIGS. 4A-9B, the material collection system 100 is coupled to the material storage portion 200. In some embodiments, the material collection system 100 is fixed to the material storage portion 200 in the combined system 300, but more preferably the material collection system is coupled in such a way that the position of the material collection system with respect to the material storage portion of the combined system is adjustable. In some embodiments, the material collection system 100 is hingedly coupled to the material storage portion 200, such that the material collection system may be moved between a lower position and an upper position. In some embodiments, the material collection system 100 is hingedly coupled to the material storage portion 200, such that the material collection system may be moved between an operating position and a transport or storage position. Various actuators may assist an operator with the transition between the operating position and the transport or storage position. In some embodiments, the actuators are controlled by an electronic or pneumatic controller, such that the transition between the operating position and the transport or storage position can be performed automatically or in response to an operator input to a control system. In some embodiments, the actuators are pneumatic cylinders, hydraulic cylinders, electric actuators and or combinations of two or more thereof.

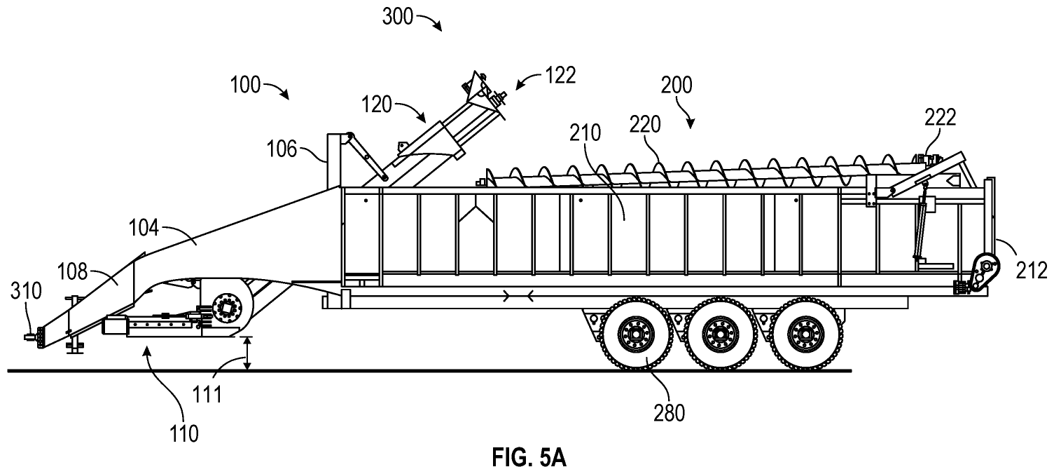

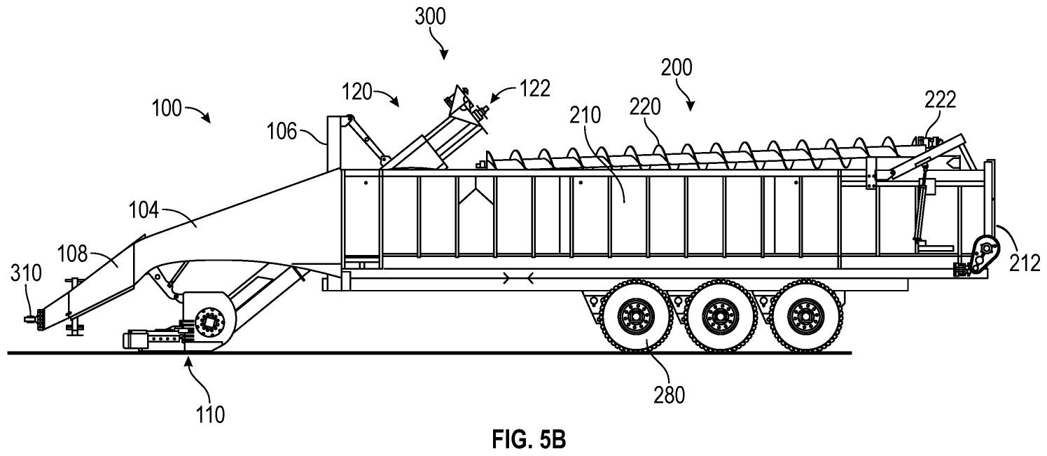

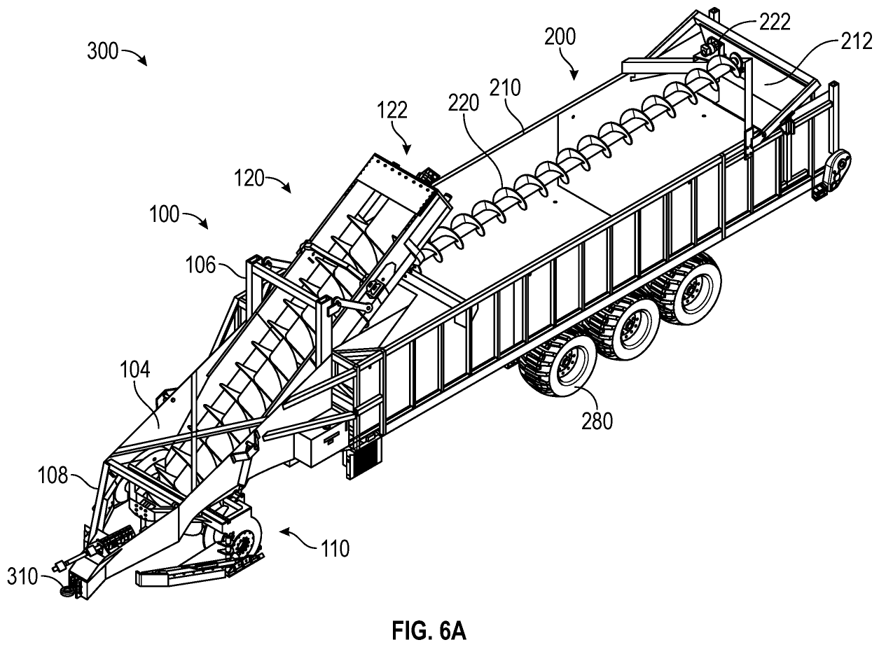

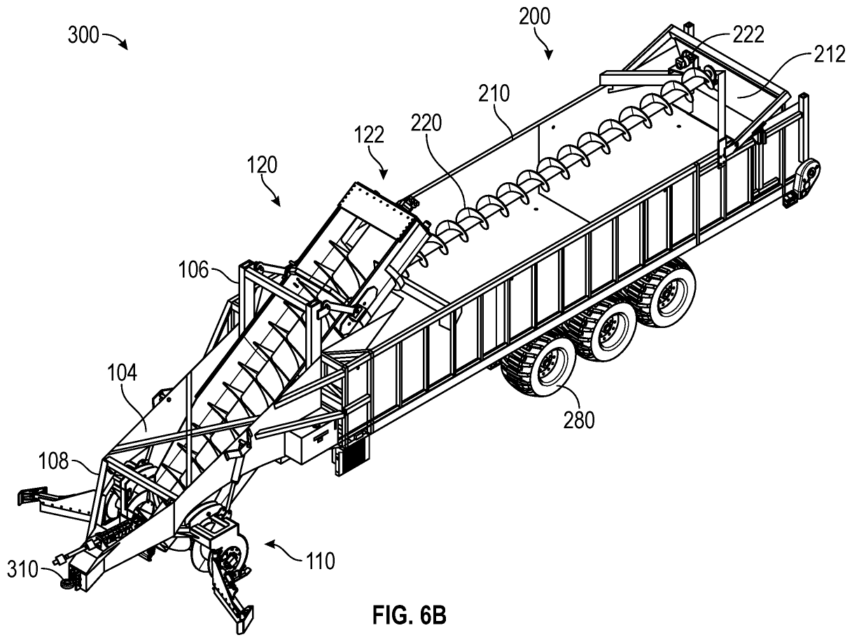

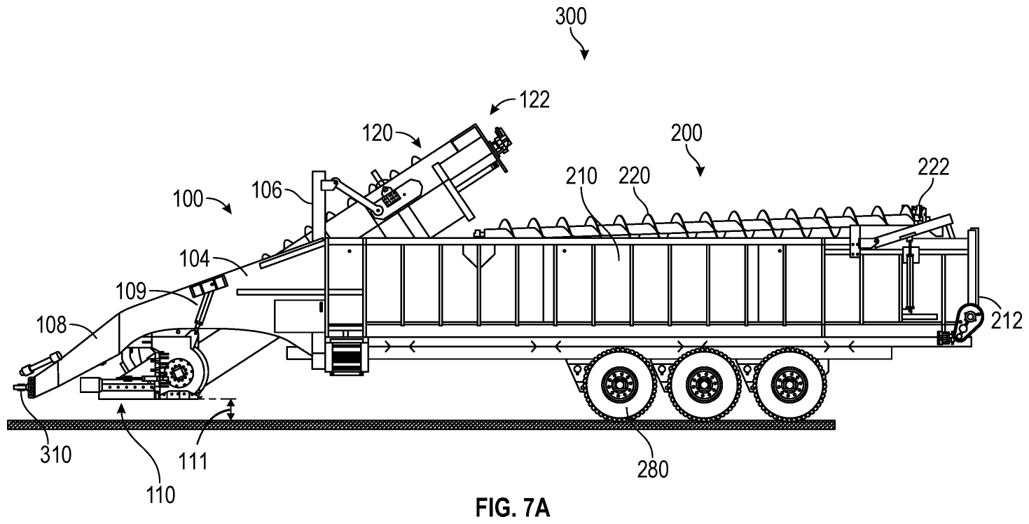

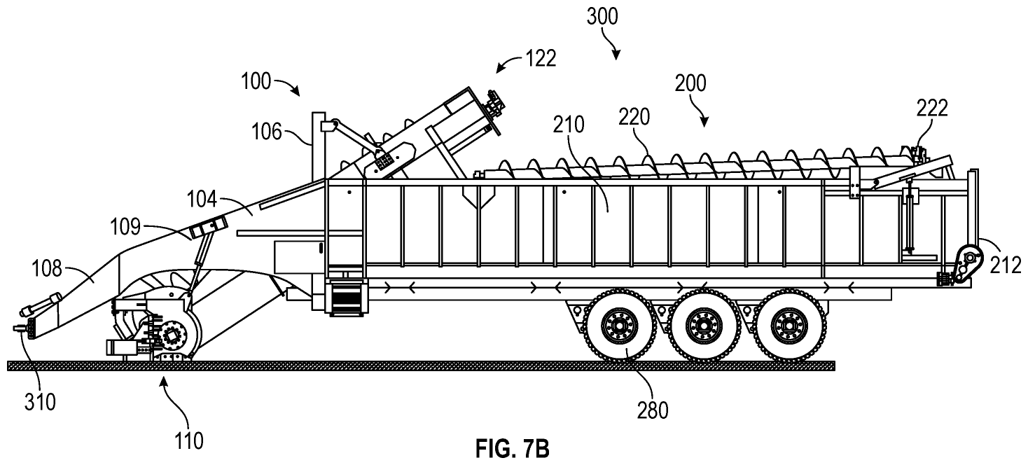

FIGS. 4A-5B shows a combined system 300 including a material collection system 100 including two loading augers in a storage or transport position (FIG. 4A, 5A) and in an operating position (FIG. 4B, 5B), where the loading augers are driven by one or more motors positioned at the top of the material collection system near the outlet 122 (see, e.g., FIG. 1A). In the operating position, the material collection system 100 is positioned at an angle such that the lower material engagement portion of the material collection system is set a short distance above the surface or ground and the wings are in an open position, allowing the combined system 300 to be operated to engage material on a surface or on the ground. In contrast, in the storage or transport position, the material collection system 100 is tilted such that the lower material engagement portion of the material collection system is raised above the surface or ground by an offset distance 111 and the wings are in a closed position, allowing the combined system 300 to be moved without risk of damage to the collection system. FIGS. 6A-7B show a similar system where the material collection system 100 has a single loading auger.

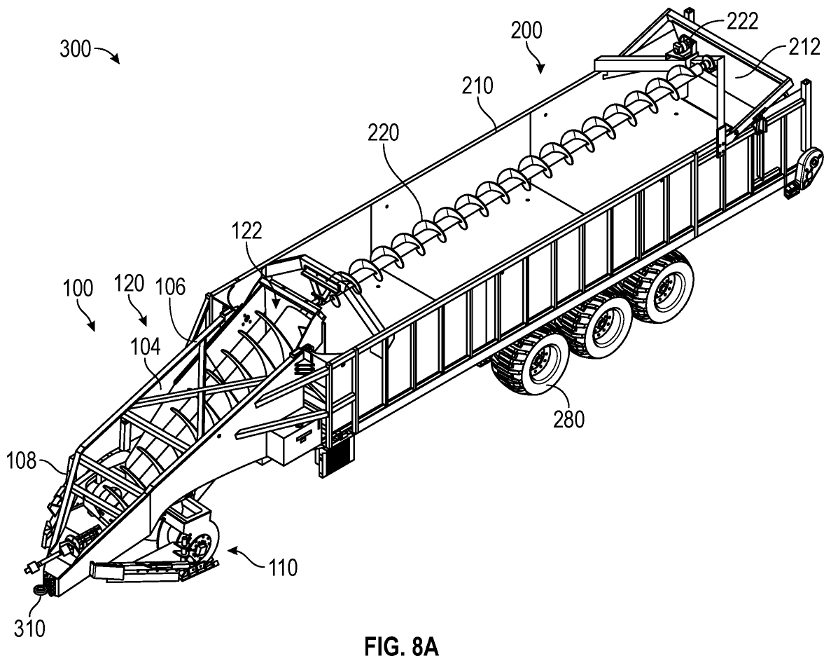

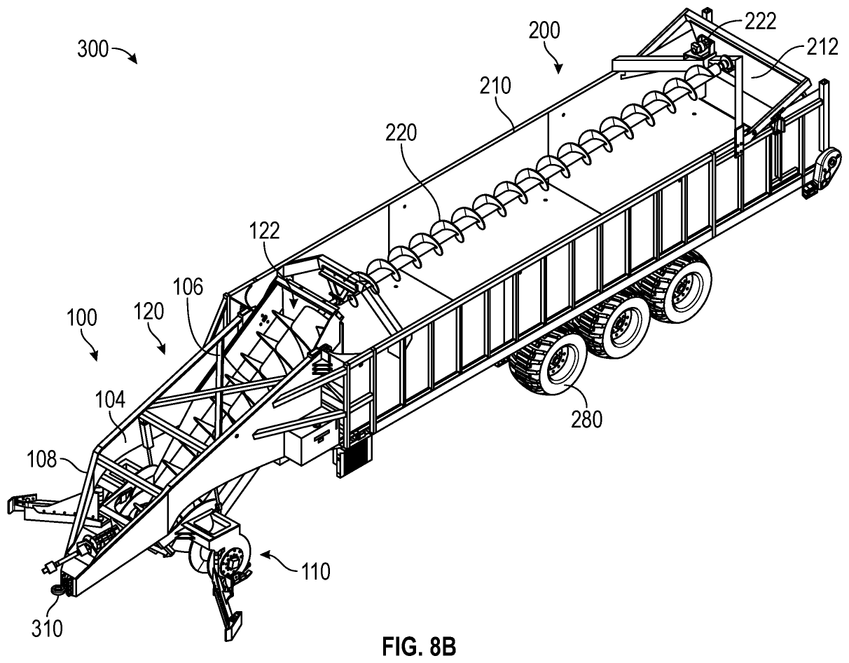

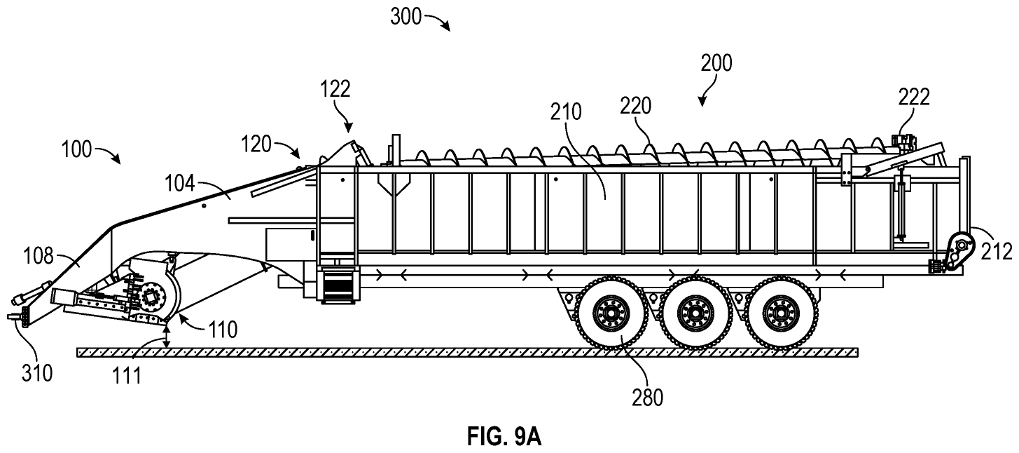

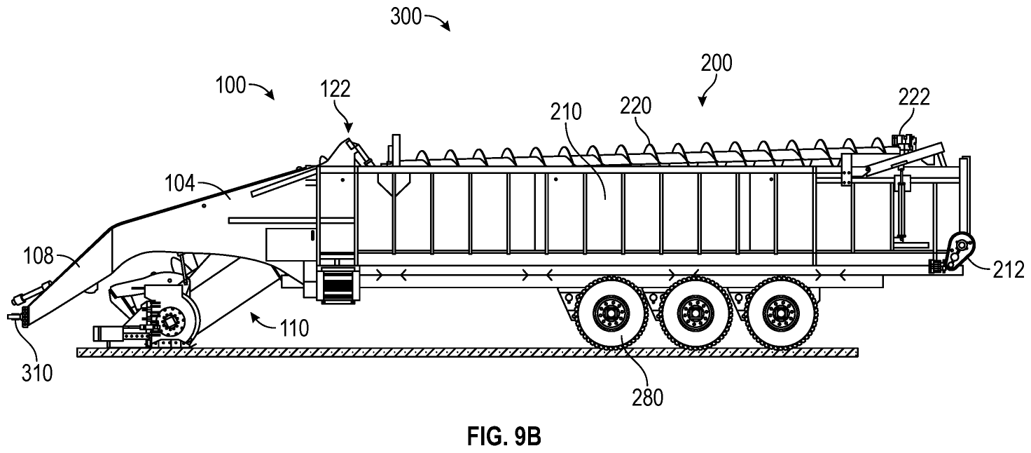

FIGS. 8A-9B shows a combined system 300 including a material collection system 100 including a single loading auger in a storage or transport position (FIG. 8A, 9A) and in an operating position (FIG. 8B, 9B), where the loading auger is driven by one or more motors positioned at near the bottom of the material collection system (see FIG. 3A, for example). In the operating position, the material collection system 100 is positioned at an angle such that the lower material engagement portion of the material collection system is set a short distance above the surface or ground and the wings are in an open position, allowing the combined system 300 to be operated to engage material on a surface or on the ground. In contrast, in the storage or transport position, the material collection system 100 is tilted such that the lower material engagement portion of the material collection system is raised above the surface or ground and the wings are in a closed position, allowing the combined system 300 to be moved without risk of damage to the collection system.

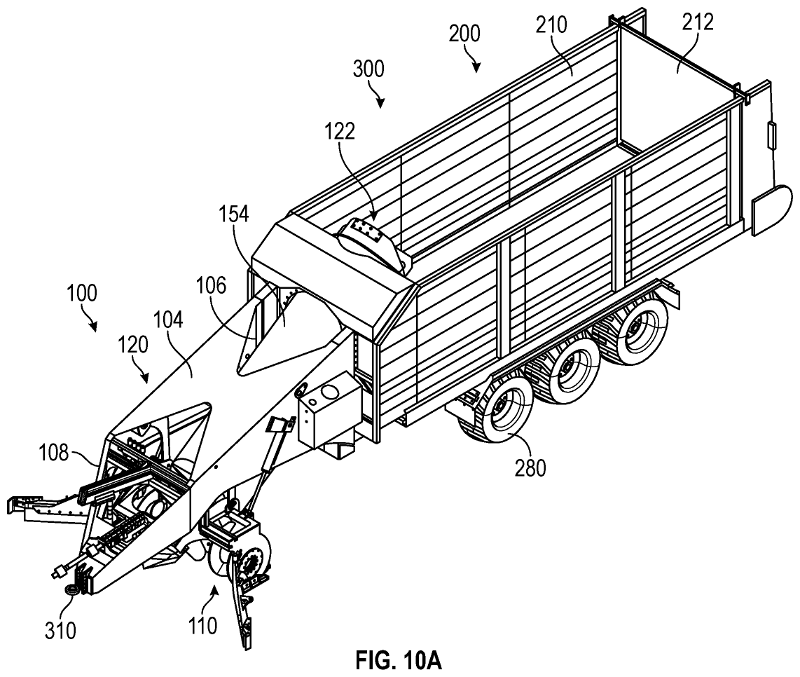

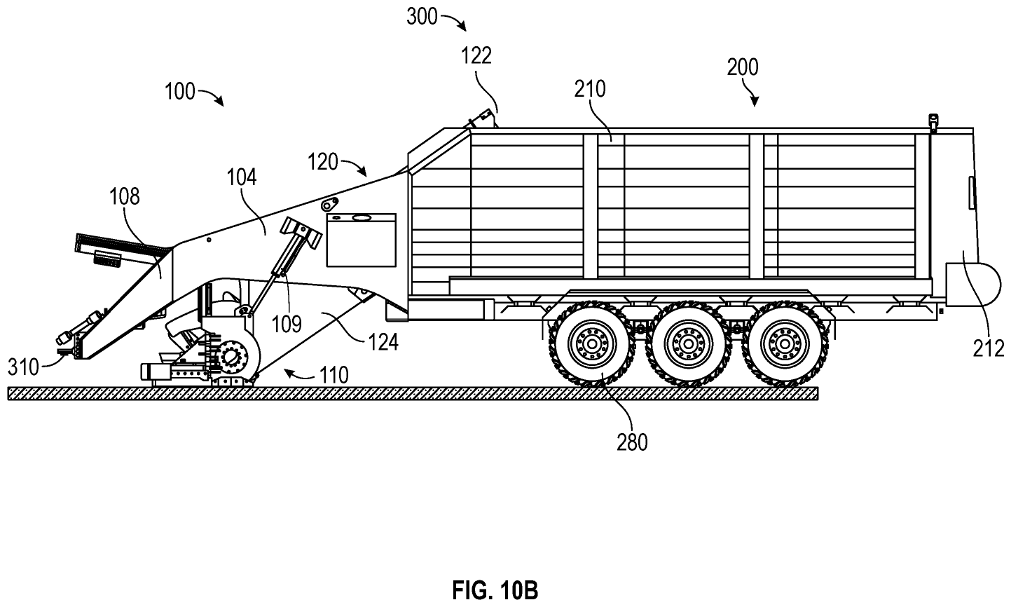

In another embodiment, illustrated in FIGS. 10A and 10B, a combined system 300 is provided that includes a material storage volume 210 and a material transport channel 124 housing a loading auger, but does not require a separate leveling auger within the storage volume. In this configuration, the material transport channel 124 is equipped with a channel cover 154 that encloses the upper portion of the channel. The presence of the cover 154 enables the loading auger to operate at increased rotational speeds without material escaping from the channel during transport. As a result, material can be propelled or ejected from the loading auger directly into the storage volume 210 with sufficient velocity and trajectory to achieve a relatively uniform distribution of material within the storage volume.

This configuration allows an operator to control the distribution of material within the storage volume by selectively adjusting the operating speed of the loading auger. By increasing or decreasing the auger speed, the operator can influence the distance and pattern with which material is discharged, thereby achieving a level or near-level load without the need for a dedicated leveling auger. This design simplifies the overall system architecture, reduces mechanical complexity, and minimizes maintenance requirements while still enabling efficient and controlled loading of material into the storage volume.

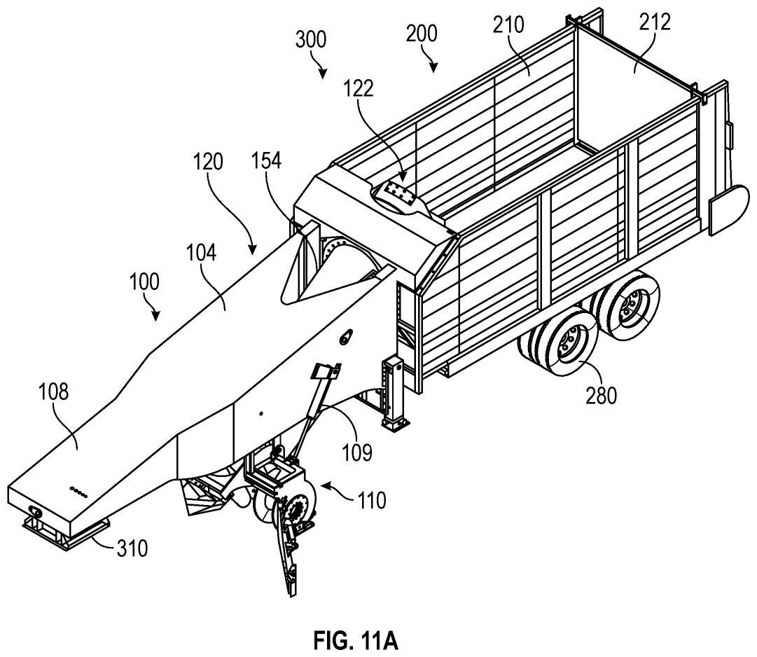

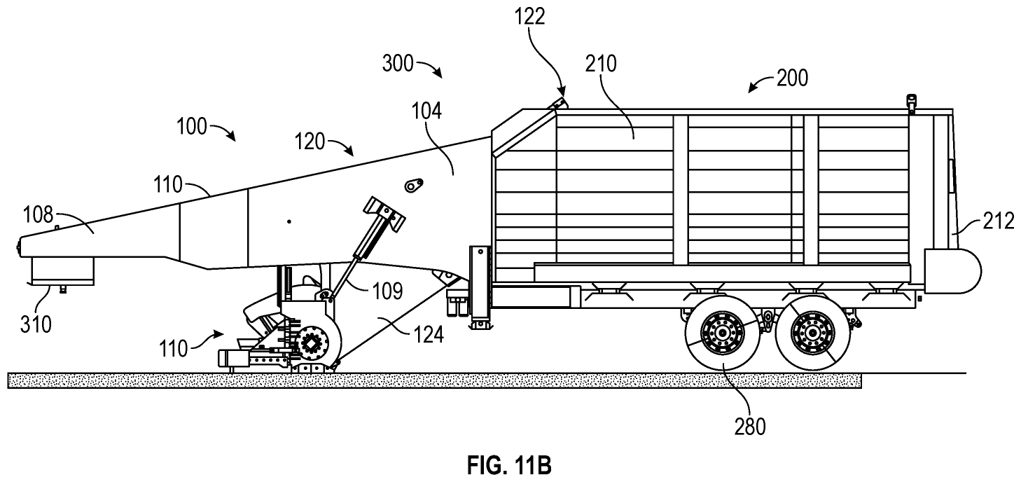

In another embodiment illustrated in FIGS. 11A and 11B, the system 300 may be configured to connect to vehicle using a fifth wheel hitch configuration. In such a configuration, the trailer tongue 108 is positioned at a height suitable for connecting a fifth wheel connector 310 to a fifth wheel hitch.

In any of the above embodiments, one or more support members 109 may be used to couple the support housing 104 or support frame 106 to the material engagement portion 110 of the system. The support members 109 may be pneumatic or hydraulic pistons, as illustrated in FIGS. 10A-11B. Alternatively, the support members may be spring loaded. The support members 109 may be actuatable, assisting with moving the engagement portion 110 between a raised position, such as for transport, and a lowered positioned for material collection. This actuation may be manual, semi-automated, or fully automated, depending on the system configuration.

The support members 109 may also serve a shock-absorbing function, biasing the material engagement portion 110 toward its extended, engaged position during operation. This biasing effect allows the engagement portion to maintain consistent contact with the surface while accommodating variations in terrain. For example, when the system encounters surface obstructions such as curbs, large rocks, or uneven ground, the support members 109 permit the engagement portion to temporarily deflect or roll over the obstruction without requiring full retraction. Once the obstruction is cleared, the biasing force of the support members 109 automatically returns the engagement portion to its lowered, engaged position. This functionality enhances the system's ability to operate smoothly over irregular surfaces, reduces the need for manual adjustments, and helps protect both the equipment and the surface from damage due to abrupt impacts or misalignment.

In various embodiments, any of the systems described herein may include a hitch 310 or other coupling mechanism configured to attach the system 300 to a vehicle. The hitch may be a standard agricultural or industrial towing hitch, such as a drawbar, pintle hook, or ball-and-socket type, and may be mounted to a frame or chassis of the system. This configuration enables the system 300 to be towed by a tractor, truck, or other powered vehicle along a desired path. As the system is pulled across a surface, the side augers and loading augers operate to collect material from the surface and convey it into the storage volume. The mobility provided by the hitch connection allows the system to be deployed in a variety of environments, including agricultural fields, feedlots, silos, livestock pens, or other material collection zones, and enables efficient transport and loading of bulk material.

### Methods of Making a Material Collection System

To manufacture the claimed material collection and transport system, the process may begin by fabricating or sourcing a material transport channel. This channel may be formed from durable materials such as stainless steel, aluminum, or reinforced polymer composites, selected based on the intended application environment (e.g., agricultural, industrial, or municipal). The transport channel is typically an elongated, hollow structure with open ends to facilitate material entry and may include internal guide surfaces or wear-resistant linings to support long-term use. The transport channel may be partially open or may define a fully enclosed channel.

A first loading auger is operatively connected to the material transport channel, with at least a portion of the auger positioned within the channel. The auger may be mounted on a central shaft supported by bearings at either end and driven by an electric, hydraulic, or other powered motor, such as a power take off (PTO) motor. The auger is configured to rotate about its longitudinal axis, thereby lifting or conveying material from the bottom portion of the transport channel toward an upper discharge point of the channel. The auger blade geometry—such as pitch, diameter, and flight spacing—may be selected to optimize flow rate and minimize clogging, depending on the type and size of material being handled.

Adjacent to the first side of the transport channel, a first side auger is mounted and operatively connected. This auger is positioned to engage material directly from the surface and convey it laterally into the transport channel. The side auger may be housed in a partially enclosed trough or shroud to guide material and prevent spillage. The auger may be angled or curved to enhance its ability to scoop or draw in material from the ground. In some embodiments, the side auger may be height-adjustable or spring-loaded to accommodate uneven terrain.

In various embodiments, a second side auger is similarly mounted adjacent the opposite side of the transport channel. This configuration allows for bilateral material intake, increasing the effective collection width and improving efficiency. The first and second side augers may be synchronized or independently controlled, allowing for selective operation based on the direction of travel or the location of material on the surface.

In some embodiments, the material storage volume is coupled to the transport channel to receive and contain the conveyed material. The storage volume may be a hopper, bin, tank, or trailer bed, and may be mounted directly behind or downstream of the transport channel's discharge point. The connection between the transport channel and the storage volume may include a chute, funnel, or transition duct to guide material flow and reduce loss during transfer. The transport channel may be hinged or pivotable, such that the angles of the channel with respect to the storage volume can be adjusted, either manually or via actuators. In this way, the direction of the material ejected from the transport channel can be controlled, further improving the distribution of material in the storage volume.

In some embodiments, a storage auger is positioned along at least a portion of the length of the storage volume. This auger may be partially or fully enclosed within the storage volume and is configured to distribute material evenly within the container or to convey it toward a discharge outlet. The storage auger may also assist in compacting or leveling the material to maximize storage capacity of the storage volume. In some configurations, the storage auger may be reversible or include variable-speed control to accommodate different material types and flow rates.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms. As used herein, “longitudinal” is intended to mean along a longer axis of the augers or other portion of the system/apparatus described and “transverse” is intended to mean perpendicular to longitudinal.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Furthermore, the foregoing systems, apparatuses and methods have been described in connection with what are presently considered to be the most practical and preferred embodiments and it is to be understood that the invention is not to be limited to the disclosed embodiments, but on the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. An apparatus comprising:
a material transport channel having a first side and an opposite second side;
a first loading auger at least partially positioned within the material transport channel; and
a first side auger positioned adjacent the first side of the material transport channel;
wherein the first side auger is configured to direct material from a surface into the material transport channel via rotation of the first side auger, and the first loading auger is configured to direct material within the material transport channel from a bottom portion of the material transport channel towards an upper portion of the material transport channel via rotation of the first loading auger.

2. The apparatus of claim 1, further comprising a second side auger positioned adjacent the second of the material transport channel, wherein the second side auger is configured to direct material from a surface into the material transport channel via operation of the second side auger.

3. The apparatus of claim 1, further comprising a second loading auger adjacent the first loading auger, the second loading auger at least partially positioned within the material transport channel, the second loading auger configured to direct material within the material transport channel from a bottom portion of the material transport channel towards an upper portion of the material transport channel via rotation of the second loading auger, the rotation of the second loading auger being counter to the rotation of the first loading auger.

4. The apparatus of claim 2, wherein a bottom portion of the material transport channel comprises a tapered end having a width that is less than a width of the upper portion of the material transport channel.

5. The apparatus of claim 1, wherein the first side of the material transport channel comprises an opening to receive material from the first side auger.

6. The apparatus of claim 1, wherein the first side auger extends partially within the material transport channel.

7. The apparatus of claim 1, further comprising a wing coupled to the first auger, the wing including an engagement portion configured to direct material from a surface toward the first side auger and, optionally, a skid configured to engage a horizontal or vertical surface.

8. The apparatus of claim 7, wherein the wing is hingedly coupled to the first auger such that an angle between the first auger and the wing is adjustable.

9. The apparatus of claim 1, wherein the first auger includes an auger screw, a motor operationally coupled to the screw so as to rotate the auger screw in operation, a screw guard positioned adjacent the auger screw and extending for at least a portion of a length of the auger screw.

10. A material loading system comprising:
a material collection portion comprising:
a material transport channel having a first side and an opposite second side;
a first side auger positioned adjacent the first side of the material transport channel and configured to collect material from a surface and direct the material towards the material transport channel;
a first loading auger at least partially positioned within the material transport channel and configured to direct material within the material transport channel from a bottom portion of the material transport channel towards an upper portion of the material transport channel; and
a material storage volume coupled to the material collection portion and configured to receive material from an outlet of the material transport channel.

11. The system of claim 10, further comprising a storage auger extending along at least a portion of a length of the material storage volume, the storage auger configured to contact material received in a front portion of the material storage volume and direct it towards a rear portion of the material storage volume via rotation of the storage auger.

12. The system of claim 10, wherein the material transport channel is hingedly coupled to the material storage volume, such than an angle of the material transport channel is adjustable.

13. The system of claim 12, further comprising a level guide positioned adjacent the bottom portion of the material transport channel, the level guide configured to contact a surface during operation of the system, the material transport channel hingedly coupled to the material storage volume such that as the level guide contacts the surface, the bottom portion of the material transport channel is maintained a predetermined distance from the surface.

14. The system of claim 10, further comprising one or more support members biasing the material collection portion in a material collection position.

15. The system of claim 10, further comprising a vehicle connection coupled to the material storage volume, the vehicle connection configured to couple to a vehicle such that a vehicle is able to tow the system.

16. The system of claim 10, wherein the system includes an engine and drivetrain, the engine and drivetrain configured to provide power to one or more wheels of the system.

17. A method making a system, the method comprising:
providing a material transport channel having a first side and an opposite second side;
operatively connecting a first loading auger to the material transport channel, the first loading auger at least partially positioned within the material transport channel; and
operatively connecting a first side auger to the material transport channel adjacent the first side of the material transport channel;
wherein the first side auger is configured to direct material from a surface into the material transport channel via rotation of the first side auger, and the first loading auger is configured to direct material within the material transport channel from a bottom portion of the material transport channel towards an upper portion of the material transport channel via rotation of the first loading auger.

18. The method of claim 17, further comprising operatively connecting a second side auger to the material transport channel adjacent the second side of the material transport channel, wherein the second side auger is configured to direct material from a surface into the material transport channel via rotation of the second side auger.

19. The method of claim 17, further comprising coupling a material storage volume to the material transport channel, the storage volume configured to receive material from the material transport channel.

20. The method of claim 19, further comprising positioning a storage auger along at least a portion of a length of the material storage volume and at least partially within the storage volume.
